(19) United States
(12) Patent Application Publication
(10) Pub. No.: US 2015/0221335 A1
(43) Pub. Date: Aug. 6, 2015

(54) Retiming in a Video Sequence

(71) Applicant: HERE Global B.V., Veldhoven (NL)

(72) Inventor: Aaron Licata, San Ramon, CA (US)

(73) Assignee: HERE Global B.V., Veldhoven (NL)

(21) Appl. No.: 14/173,583

(22) Filed: Feb. 5, 2014

(51) Int. Cl. G11B 27/00; H04N 9/87; G11B 27/031

(52) U.S. Cl. CPC G11B 27/005; G11B 27/031; H04N 9/87

(57) ABSTRACT

Slow motion is added to a video clip using retiming. Retiming adjusts the timing of the video. The video sequence may be stored ahead of time, modified in real time as the video is collected, or in real time as the video is played back. A memory stores a video sequence. A processor selects a subset of frames from the video sequence based on a focus frame identifier and a slow motion timing pattern. The processor generates at least one intermediate frame for insertion into the subset of frames based on the slow motion timing pattern for the video sequence and the focus frame identifier for the video sequence.

### FIELD

The following disclosure relates to the timing of a video sequence, or more particularly, retiming a video sequence based on analysis of the video sequence, for example based on the detection of motion activity climax or motion activity saliency.

### BACKGROUND

Slow motion filmmaking introduces an effect in which time appears to slow down. Video may be corrected at a high speed and then played back at a low speed to simulate the appearance of time moving more slowly. In one example, slow motion filmmaking with a hand crank video camera involves overcranking the camera at a higher speed than normal, which causes the film when played at a normal speed to appear in slow motion. Slow motion may also be achieved by simply playing video at slow speed.

When the slow motion video is created by high speed recording or overcranking, the slow motion speed is set and cannot be changed. Other slow motion techniques also play video at a constant speed. Challenges remain is customization of slow motion video.

### SUMMARY

Slow motion is added to a video clip using retiming. Retiming adjusts the timing of the video. The video sequence may be stored ahead of time, modified in real time as the video is collected, or in real time as the video is played back. A memory stores a video sequence. A processor selects a subset of frames from the video sequence based on a focus frame identifier and a slow motion timing pattern. The processor generates at least one intermediate frame for insertion into the subset of frames based on the slow motion timing pattern for the video sequence and the focus frame identifier for the video sequence.

### BRIEF DESCRIPTION OF THE DRAWINGS

Exemplary embodiments of the present invention are described herein with reference to the following drawings.

FIG. 1 illustrates an example system for retiming a video sequence.

FIGS. 2A and 2B illustrate example discrete timing curves.

FIGS. 3A and 3B illustrate example continuous timing curves.

FIG. 4A illustrates an example initial video sequence.

FIG. 4B illustrates an example modified video sequence.

FIG. 5 illustrates another example modified video sequence.

FIG. 6 illustrates an example user interface for retiming a video sequence.

FIG. 7 illustrates an example motion vector.

FIG. 8 illustrates an example motion vector field.

FIG. 9 illustrates example bins for a motion vector field.

FIG. 10 illustrates an example calculation of a motion score.

FIG. 11 illustrates an example plot of a motion curve.

FIG. 12 illustrates an exemplary server of the system of FIG. 1.

FIG. 13 illustrates an exemplary mobile device of the system of FIG. 1.

FIG. 14 illustrates an example flowchart for detection of motion activity saliency.

FIG. 15 illustrates an example flowchart for retiming a video sequence.

### DETAILED DESCRIPTION

Slow motion video may be generated by generating new video frames and inserting the new video frames between existing frames. The new frames effectively slow down the video because there are more frames to play back. The original capture frame rate is reduced to the slower playback rate because of the additional frames. While other slow motion techniques may be limited to specialized video editing equipment, the retiming techniques described below may be performed by a handheld camera or a mobile phone with a camera.

Humans can easily view a video sequence and identify the more notable, interesting, or important portions of the video sequence. The term “salient feature” may refer to the more notable, interesting, or important features in the video sequence. Video frames with salient features may include more action or more movement than the preceding frames and/or subsequent frames. Examples of salient features include a player kicking a ball, a car crashing into a wall, or fireworks exploding in air.

Identifying the portion of a video that includes kicking a ball, crashing a car, or exploding fireworks is easy for the human observer. However, automating this identification is difficult. Without human intervention, salient features are not easily identified. The following embodiments include hardware and software specialized to identify the video frame or frames containing salient features (e.g., the most dramatic moment). The salient features may be defined to apply to all types of actions irrespective of the specific type of actions. In other words, the salient features are the moment or moments in a video sequence that observers usually consider the most important and visually interesting form a motion perspective.

One or more of the following examples detect such salient features by tracking the motion of pixels in frames of the video sequence and by detecting inversions of direction and velocity intensity changes of moving objects. When an object or subject undergoes an abrupt change of direction or the velocity of the object or subject increases or decreases significantly, the corresponding frames of the video sequence are identified. In one example, individual frames are identified and/or extracted at a mobile camera viewfinder in real time. In another example, a stored video is analyzed to identify and/or extract frames potentially including salient features. The salient features may be automatically selected for retiming so that the salient feature is played in slow motion.

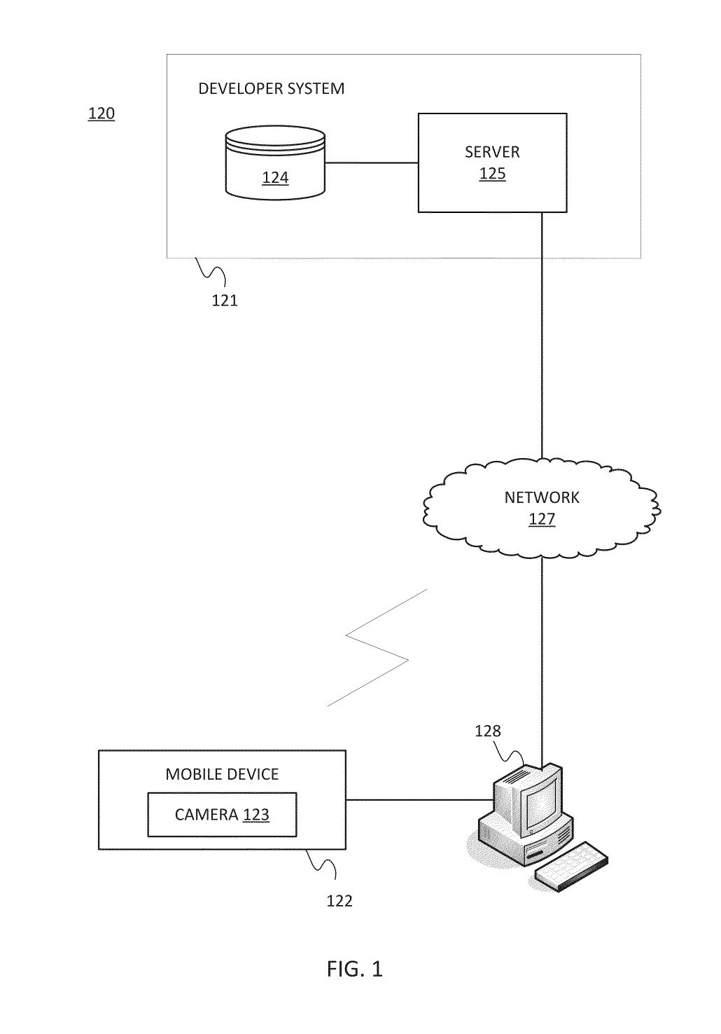

FIG. 1 illustrates an example system 120 for retiming a video sequence. The system 120 may include a developer system 121, a mobile device 122 including a camera 123, a workstation 128, and a network 127. Additional, different, or fewer components may be provided. For example, many mobile devices 122 and/or workstations 128 connect with the network 127. The developer system 121 includes a server 125 and a database 124. The developer system 121 may include computer systems and networks of a system operator (e.g., a cellular provider, a web service operator). Addition, different, or fewer components may be included in system 120.

The camera 123 collects a series of images or a video sequence. The video sequence may be stored at the database 124 or internally at the mobile device 122. The video may be analyzed by a processor at the mobile device 122, the workstation 128, or server 125. The processor of the mobile device 122 may receive the video sequence from memory or the camera 123. The processor of the server 125 may receive the video sequence from the mobile device 122 or from memory.

The processor selects a retiming code for the video sequence. The retiming code defines the rate of the slow motion. The retiming code may define a variable rate for the slow motion. For example, the rate of the slow motion may gradually decrease from the normal video rate to a focus point and then gradually increase back to the normal video rate. The retiming code may define the rate of change for the video rate when decreasing to the slowest speed and the rate of the change for the video rate when increasing from the slowest speed back to the normal video rate.

The focus point for the video may be the portion of the video for which slow motion is desired. The focus point may be a single frame or a group of frames. A focus frame identifier describes the single frame of group of frames, for example by frame number or by timestamps. The focus point may be selected by user input, set at a predetermined time location or frame number, or detected. The focus point may be detected as a salient feature in the video in which the action of the video appears to be at a climax. Various examples of the detection of salient features are described below.

The processor is configured to access the focus frame identifier from memory. Based on frames identified in the focus frame identifier, the processor selects a subset of frames from the video sequence based on the focus frame identifier and the retiming code. For example, the focus frame identifier may list frame 100 and the retiming code may list slow motion rates for the preceding 5 frames and subsequent 5 frames from the focus point. Accordingly, the process is configured to insert intermediate frames frames from frame 95 to frame 105.

The processor is configured to generate the intermediate frames. The intermediate frames may be generated from interpolated motion data to estimate or track the motion that occurred between frames. In one example, the processor identifies motion vectors that describe the motion in the frames or the pixels in the frames. The intermediate frames are generated by determining an intermediate point on the motion vectors. For example, if an object pixel is depicted at [X1, Y1] in a first frame and [X2, Y2] in a second frame, the processor may generate an intermediate frame depicting the object pixel at [(X2−X1)/2, (Y2−Y1)/2]. In another example, the processor may generate three intermediate frames depicting the object pixel at [(X2−X1)/4, (Y2−Y1)/4], [(X2−X1)/2, (Y2−Y1)/2], and [3(X2−X1)/4, 3(Y2−Y1)/4]. The processor inserts the at least one intermediate frame into the subset of frames.

The mobile device 122 is a smart phone, a mobile phone, a personal digital assistant (“PDA”), a tablet computer, a notebook computer, and/or any other known or later developed portable or mobile computing device including a camera.

The optional workstation 128 is a general purpose computer including programming specialized for analyzing the video and calculating motion scores. The workstation 128 may download the video data from the mobile device 122 and analyze the video. Alternatively, the mobile device 122 may download the video data from the mobile device 122 and send the video data to the server 125 for analysis. The workstation 128 includes at least a memory, a processor, and a communication interface.

The developer system 121, the workstation 128, and the mobile device 122 are coupled with the network 127. The phrase “coupled with” is defined to mean directly connected to or indirectly connected through one or more intermediate components. Such intermediate components may include hardware and/or software-based components.

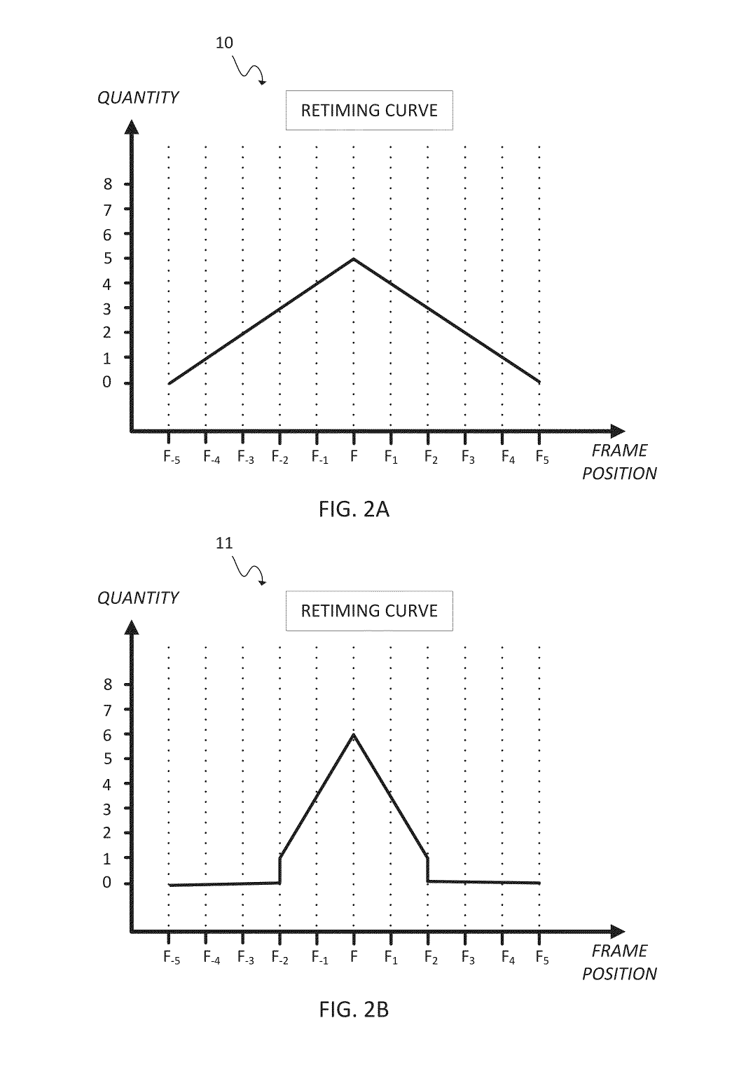

FIGS. 2A and 2B illustrate example discrete timing curves. The timing curves may define the number of frames to be inserted before (or after) a subset of frames. In FIG. 2A, the subset of frames a focus frame at position F, preceding frames at positions F₋₁ through F₋₅, and subsequent frames at positions F₁ through F₅. In FIG. 2A, the rate of change of the slow motion speed is linear. No frames are inserted before position F₋₅, one frame is inserted before position F₋₄, two frames are inserted before position F₋₃, three frames are inserted before position F₋₂, four frames are inserted before position F₋₁, and five frames are inserted before position F. The opposite pattern is used for the subsequent frames at positions F₁ through F₅.

In FIG. 2B, the rate of change of the slow motion speed is linear and at a higher rate of increase and decrease than in FIG. 2A. The subset is also smaller at five frames. No frames are inserted before position F₋₃, one frame is inserted before position F₋₂, three frames are inserted after position F₋₁, and six frames are inserted before position F. The opposite pattern is used for the subsequent frames at positions F through F₂.

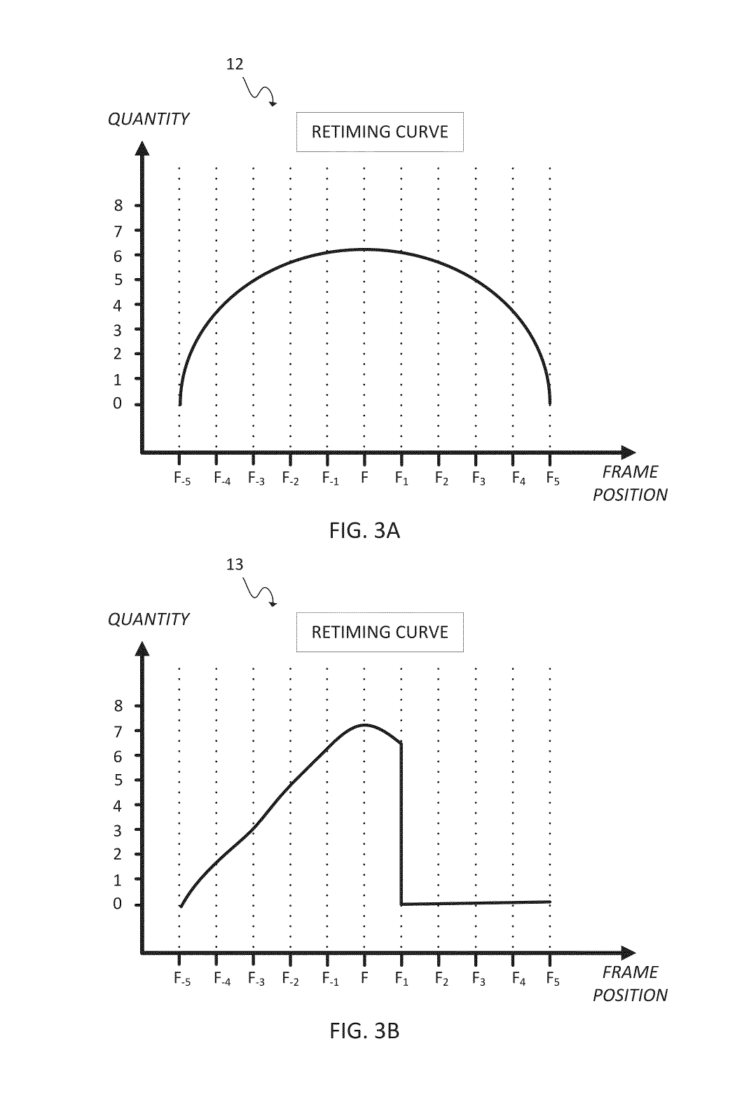

FIGS. 3A and 3B illustrate example a more general continuous timing curves, and non-linear slow motion speed. Any shape for the timing curves may be used. Examples include normal curve, bell curve, semi-circle (as shown by retiming curve 12 in FIG. 3A), parametric, quadratic, second order, logarithmic, or exponential curves or functions. The processor may round or estimate the nearest whole integer value closest to the continuous curve for the number of frames to insert between original frames. Alternatively, the processor may use a floor function to map the value from the continuous function to the greatest included or previous whole integer or a ceiling function to map the value from the continuous function to the next or smallest following whole integer.

As shown in FIG. 3B, the retiming curve 13 may not be symmetrical. In one example, intermediate frames are inset into frames of the subset that precede the focus frame F. In another example, as shown by retiming curve 13, frames may be inserted after five preceding frames but only one subsequent frame.

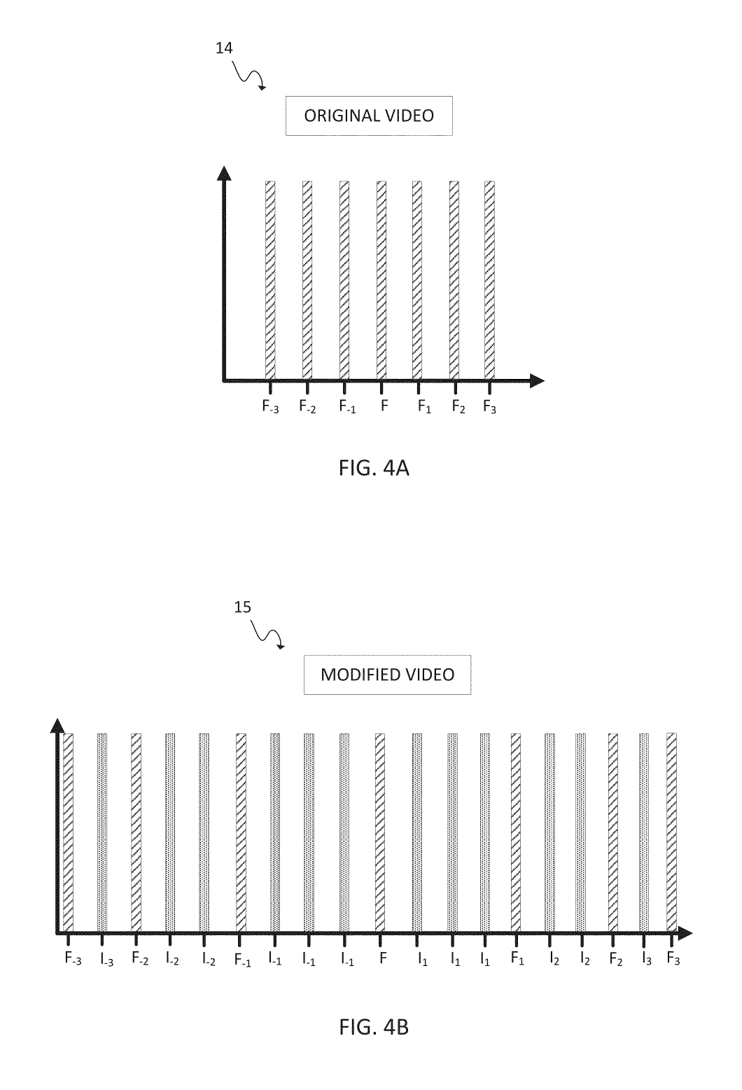

FIG. 4A illustrates an initial video sequence. A portion of the initial video sequence, or a subset of frames is illustrated. The subset includes seven original frames F₋₃ to F₃. The processor modifies the initial video sequence by inserting intermediate frames into the video sequence. FIG. 4B illustrates a modified video sequence. The processor may insert a different quantity of intermediate frames between each pair of original frames. Three intermediate frames I₁ are inserted between the focus frame F and subsequent frame F₁. Two intermediate frames I₂ are inserted between frame F₁ and frame F₂. One intermediate frame I₃ is inserted between frame F₂ and frame F₃. As shown in FIG. 4B, a similar pattern may be applied to the preceding frames.

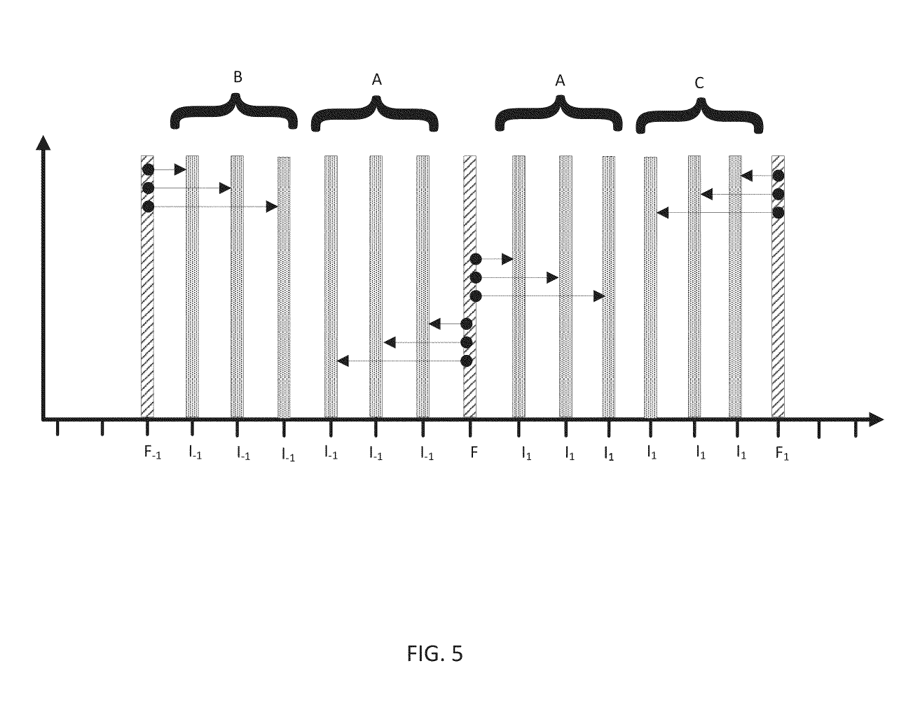

FIG. 5 illustrates another example modified video sequence including six intermediate frames between the focus frame F and the preceding frame F₋₁ and between the focus frame and the subsequent frame F₁. The six intermediate frames may be generated from interpolation based on an optical flow algorithm. As shown by the arrows in FIG. 5, the first three intermediate frames, labeled A in FIG. 5, in either direction may be generated from applying the optical flow algorithm at the focus frame F. The preceding three intermediate frames, labeled B in FIG. 5, may be generated by applying the optical flow algorithm at the preceding frame F₋₁ in the direction of the focus frame. The subsequent three intermediate frames, labeled C in FIG. 5, may be generated by applying the optical flow algorithm at the subsequent frame F₁ in the direction of the focus frame.

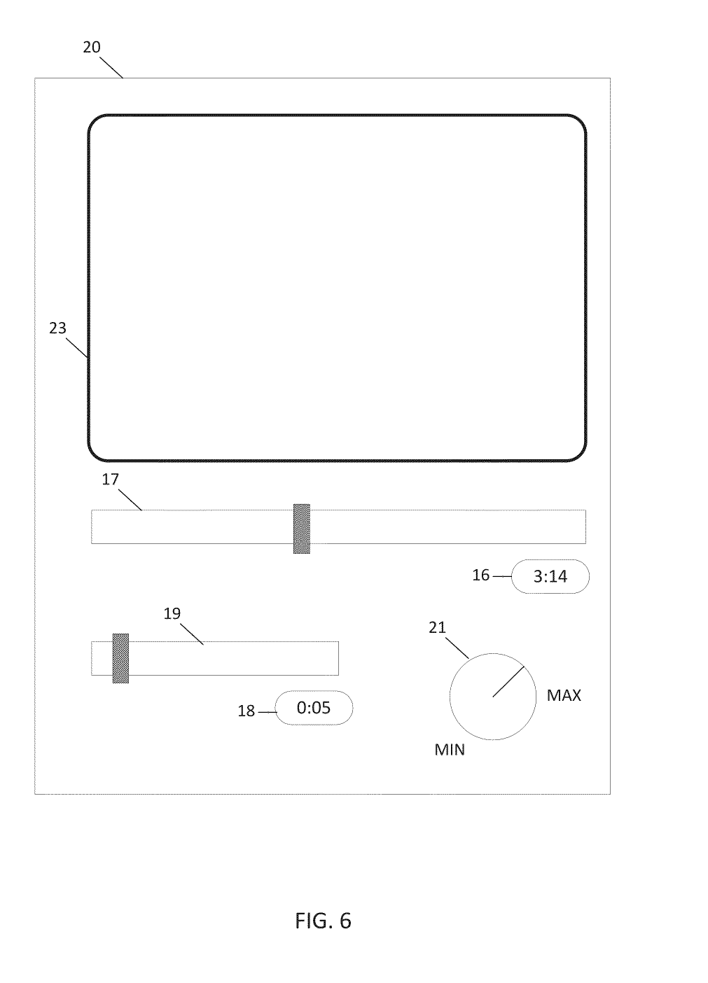

FIG. 6 illustrates an example user interface 20 for retiming a video sequence. The user interface 20 may be included on the mobile device 122. The user interface 20 may include multiple control portions for retiming a video 23. In one example, the user interface 20 includes a focus frame selector 17, a retiming spread selector 19, and a retiming speed selector 21.

The focus frame selector 17 receives a user input to select the point or frame to be retimed in slow motion. The focus frame selector 17 may be a text input field, a scroll bar, a scrubber bar or a physical input device. The example shown in FIG. 6 includes a scrubber bar and a textual output 16. The textual output 16 may display the time (e.g., in minutes and seconds) of the focus frame in the video sequence or the frame number in the video sequence. The focus frame selector 17 may output a focus frame command defining the time stamp or frame number for the processor.

The retiming spread selector 19 receive a user input to define how much of the video sequence to retime. The retiming spread selector 19 may define how much of the video is converted to slow motion. The retiming spread selector 19 may define the size of the subset of frames. The retiming spread selector 19 may be a text input field, a scroll bar, a scrubber bar or a physical input device. The example shown in FIG. 6 includes a scrubber bar and a textual output 18. The textual output 18 may display the time (e.g., in minutes and seconds or seconds and tenths of seconds) of the size of the retiming portion of the video sequence or the number of frames in the retiming portion of the video sequence. The retiming spread selector 19 may output a command defining the time or number of frames for the retiming portion of the processor.

The retiming speed selector 21 may be configured to receive a user input defining the rate of increase and/or decrease of the slow motion. The retiming speed selector 21 may include a text input, a scroll bar, a slider, a dial, or a physical input. The user input may define how many interpolated intermediate frames are inserted between frames. The user input may define a slope of the retiming curve or a shape of the retiming curve. The retiming speed selector 21 may output a speed command including data indicative of the slope of the retiming curve or the shape of the retiming curve for the processor. The physical input devices in these examples may include one or more of include dials, switches, or other manually operated inputs.

The processor may generate a motion vector field including motion vectors for pixels in the video. The motion vectors may describe the movement of a pixel from one frame to the next or to a subsequent frame. The motion vectors may be calculated using an optical flow algorithm, or an approximate and dense motion estimation. The optical flow algorithm may analyze the series of images to identify the movement of edges, surfaces, or objects in the video. The motion vectors describe the movement of the edges, surfaces, or objects in the video. Each motion vector may describe a translation of a pixel from one position in one frame to a second position in the next or a subsequent frame. The motion vectors for multiple pixels in a frame may be referred to as motion vector field.

The processor may generate two sets of motion vectors. One set of motion vectors may have a lower quality or accuracy, and the other set of motion vectors may have a higher quality or accuracy. The low quality motion vectors may be used for detection of the focus frame, and the high quality motion vectors may be used for frame interpolation.

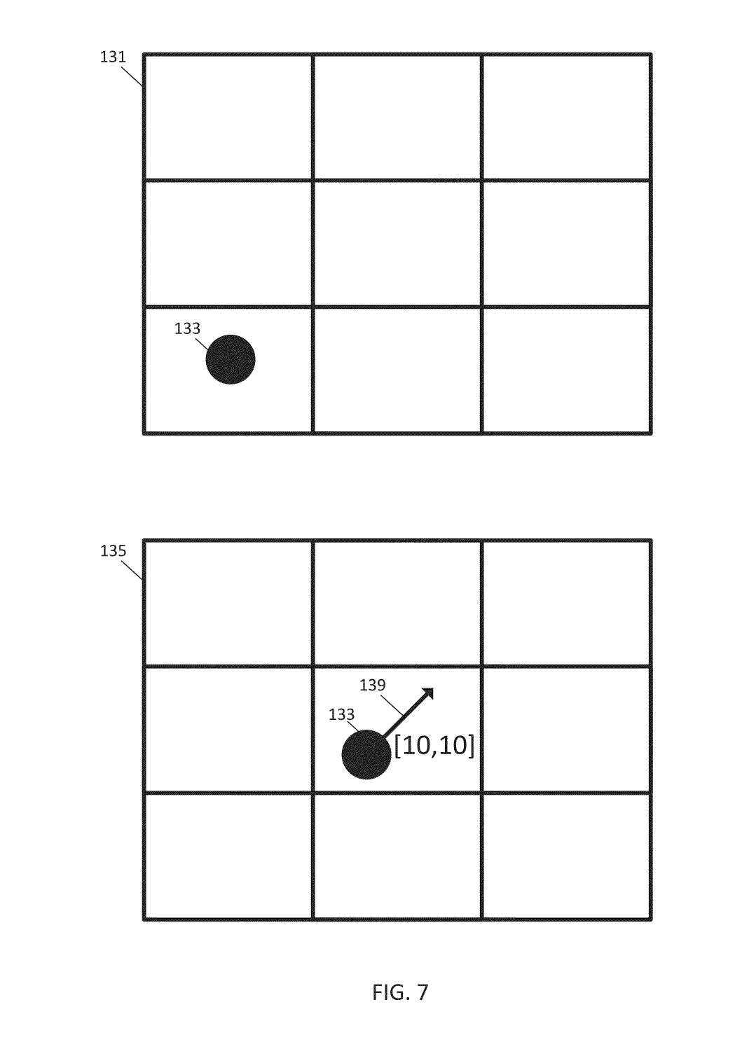

FIG. 7 illustrates two consecutive video frames, including a first frame 131 and a second frame 135. The video frames may depict multiple objects that move in various directions from the first frame 131 to the second frame 135. For the purpose of illustration, FIG. 7 includes one object 133. From the first frame 131 to the second frame 135, the object 133 moves up and to the right (e.g., northeast). The direction of travel of the object 133 is described by vector. The motion vector may comprise two components. One component may be a horizontal distance, and one component may be a vertical distance. The movement may be 10 pixels or other units vertically and 10 pixels or other units horizontally. The motion vector may be normalized to a unit length of one.

The processor may interpolate positions for the object 133 along the motion vector. In one example, the position of the object 133 may be interpolated to [5, 5] for one intermediate frame. In another example, the position of the object 133 may be interpolated to [3, 3] and [6, 6] for two intermediate frames, respectively, by truncated the remainder of the position coordinates. In another example, the position of the object 133 may be interpolated to [3, 3] and [7, 7] by rounding to the nearest known position (i.e., because [6.66, 6.66] is closer to the position in the second frame 135, the intermediate frame closer to frame 135 rounds to [7, 7]).

The optical flow algorithm may also bias object positions in intermediate frames towards the closest original frame. In some cases forward and backwards interpolation might not coincide. That is, the vector at position [0, 0] computed by the optical flow from frame F0 to F1 (forward in time) might stretch at location [10, 10]. Therefore, the halfway vector is interpolated to [5, 5]. By contrast, if the optical flow computes the vector at position [10, 10] from frame F1 to F0 (backward in time) then the resulting vector end point might be [0, 2]. Therefore, the half-way vector is interpolated to [5, 4] instead of [5, 5] in the forward counterpart.

The processor is configured to calculate a first motion vector using an optical flow algorithm from a first frame of the subset of frames to a second frame of the subset of frames and calculate a second motion vector using the optical flow algorithm from the second frame of the subset of frames to the first frame of the subset of frames.

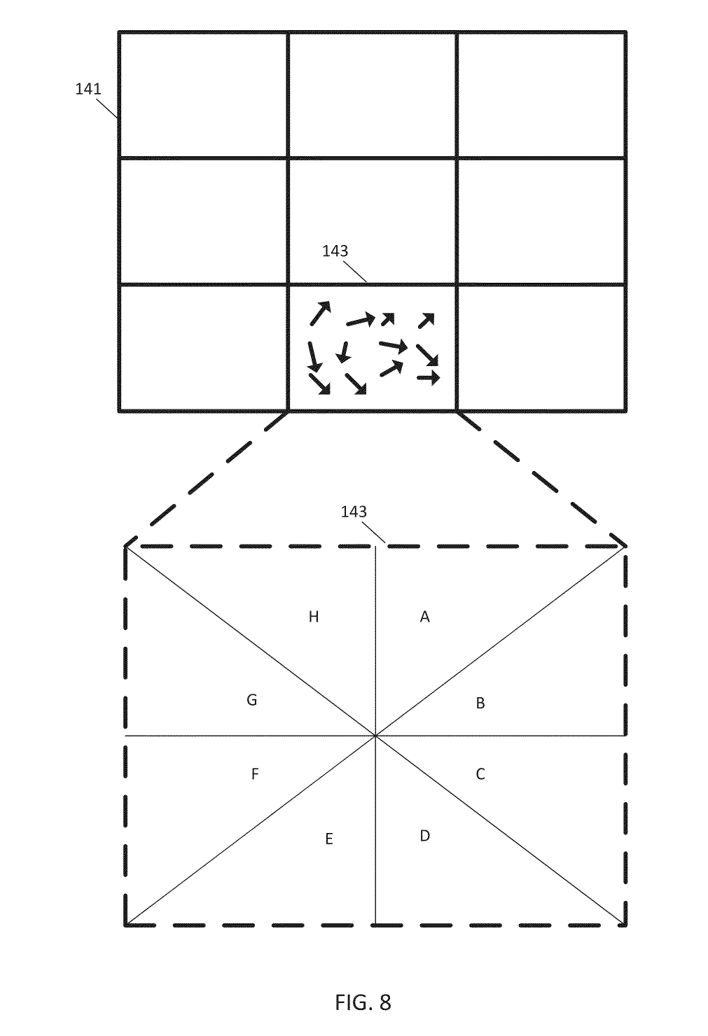

FIG. 8 illustrates an example motion vector field comprising motion vectors. The frame 141 is divided or portioned into grid blocks. The grid blocks may divide the video frames into equal portions or unequal portions. The number of grid blocks is selectable. Example numbers of grid blocks are 4, 9, 16, 25, 100, and 256. In one example, each grid block is 7 pixels by 13 pixels. Each of the grid blocks includes a moving object includes at least one motion vector. Together, the motion vectors in each of the grid blocks form a motion vector field. For the ease of illustration only grid block 143 is illustrated with a motion vector field. Within each grid block, the processor may bin or organize the motion vectors into one of a set of orientation ranges. The orientation ranges may divide the motion vectors further. Each motion vector has a direction or orientation.

The grid block 143 may be divided into orientation ranges A-H. Each of the orientation ranges is assigned an angle in degrees or radians. The angles may be measured from any point. For example, the angles may be measured from the positive vertical axis such that range A corresponds to 0 to Pi/4 radians, range B corresponds to Pi/4 radians to Pi/2 radians, range C corresponds to Pi/2 to 3Pi/4 radians, range D corresponds to 3Pi/4 to Pi radians, range E corresponds to Pi to 5Pi/4 radians, range F corresponds to 5Pi/4 to 3Pi/2 radians, range G corresponds to 3Pi/2 to 7Pi/4 radians, and range H corresponds to 7Pi/4 to 2Pi radians. The orientation may be an angle measured from the positive X-axis. For example, four orientation ranges may be 1 to 90 degrees, 91 to 180 degrees, 181 to 270 degrees, and 271 to 360 degrees. The processor sorts the motion vectors into the orientation ranges. The processor calculates a motion score based on a count of motion vectors for at least one of the orientation ranges. The motion score may be stored at the database 124 or locally at the mobile device 122.

The motion score may be incorporated into the video as metadata. For example, each frame in the video may be associated or stored with a motion score. The processor may compare the motion scores and identify the highest motion score or a group of high motion scores. The frame with the highest score may be used as the focus frame. The processor may generate the focus frame identifier with the frame number or frame location with the highest motion score.

Alternatively or in addition, the frame with the highest score may be used as a thumbnail for the video. The frames with the highest score may be used as a highlight clip for the video. Frames with scores above a threshold may be used as advance points. When the video is advanced or fast forwarded, the video skips ahead to the next advance point.

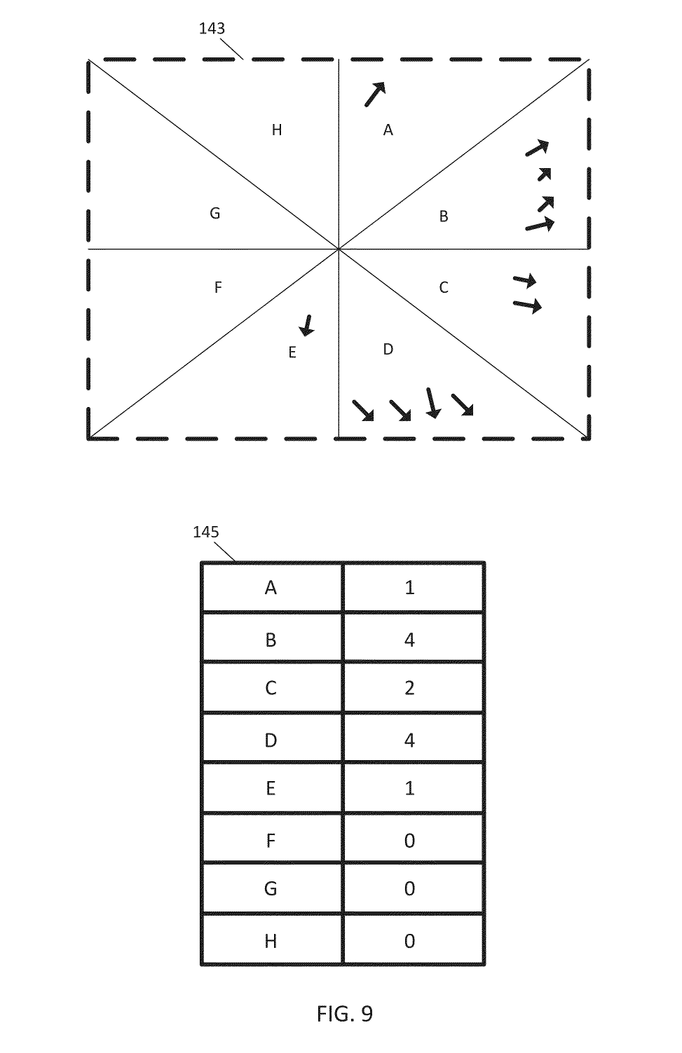

FIG. 9 illustrates example bins for organizing the motion vector field. The grid block is illustrates with each of the vectors drawn in the corresponding orientation ranges. Each of the vectors points in the direction of the orientation range on which it is drawn. The example of FIG. 9 is merely illustrative. The server 125 may arrange the data representing the vectors using indexes and tables. The vectors may be organized in a histogram.

The table 145 illustrates a quantity of vectors in each of the orientation ranges. For example, orientation range A includes one vector and orientations ranges B and D each include four vectors. The table 145 may include the magnitudes of the vectors. For example, the server 125 may sum the magnitudes of the vectors in each orientation range.

In another example, the server 125 may assign count values for the vectors. Vectors with a magnitude in a small range may be assigned a count value of one, vectors with a magnitude in a medium range may be assigned a count value of two, and vectors with a magnitude in a high range may be assigned a count value of three. The ranges may be defined statistically (e.g., based on 1, 2, or 3 standard deviations from a mean of all the vectors in the frame or the video sequence) or statically (e.g., based on user input or other predetermined values).

In another example, the count values may be calculated based on the percentage of the vertical height or horizontal height of the frame. For example, a small count value may be assigned to vectors from 0% to 25% of the vertical height, a medium count value may be assigned to vectors from 26% to 75% of the vertical height, and a high count value may be assigned to vectors from 76% to 100% of the vertical height. The server 125 may include a table that associates vectors lengths to count values.

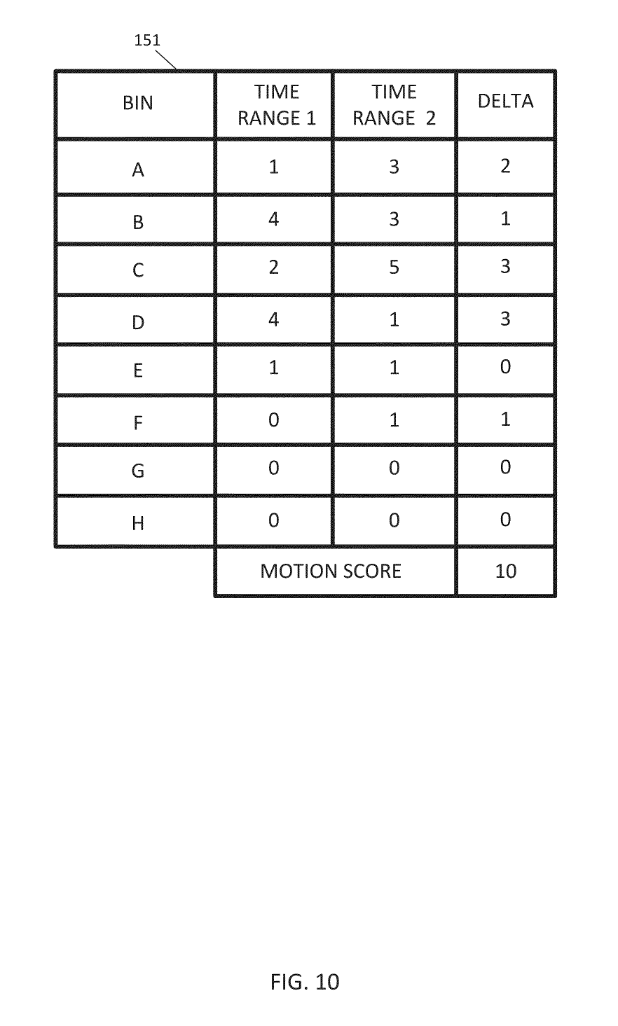

FIG. 10 illustrates an example calculation of a motion score in table 145. The server 125 may calculate the count values for multiple frames or frames of multiple time ranges. The time ranges may be a predetermined number of frames (e.g., 5 frames, 10 frames or another quantity) or a predetermined duration of time (e.g., 1 second, 2 seconds, or another duration). The server 125 calculates the total count values for each of the bins or orientation ranges.

The server 125 compares the total count values for each of the bins or orientation values. For example, the server 125 subtracts the total count value for one time period from the total count value for another time period. The absolute value of the difference is shown by the delta column in table 145. The server 125 sums all of the delta values to determine the motion score when moving from time range 1 to time range 2. The next motion score, moving from time range 2 to time range 3, is calculated based on the total count values for time range 2 and time range 3. For each pair of subsequent time ranges, or subsequent video frames, another motion score is calculated.

The server 125 may sum all of the delta values to determine the motion score across all of the grid blocks when moving from time range 1 to time range 2. Center grid blocks may be weighted higher than border grid blocks. For example, a moderate level of motion in a center grid block may receive a higher motion score than a high level of motion in an off-center grid block or grid block near the edge of the frame. The server 125 may determine a grid block weight that is inversely proportional to a distance from the center of the frame. The motion score for each grid block may be multiplied by the grid block weight. For example, the center 25% of the grid blocks may be assigned a weight of 2, which doubles the associated motion scores, the middle 50% of the grid blocks may be assigned a weight of 1, which does not alter the associated motion scores, and the outer 25% of grid blocks may be assigned a weight of ½, which reduces in half the associated motion scores. In one example, only the center grid blocks are used for calculating the motion score.

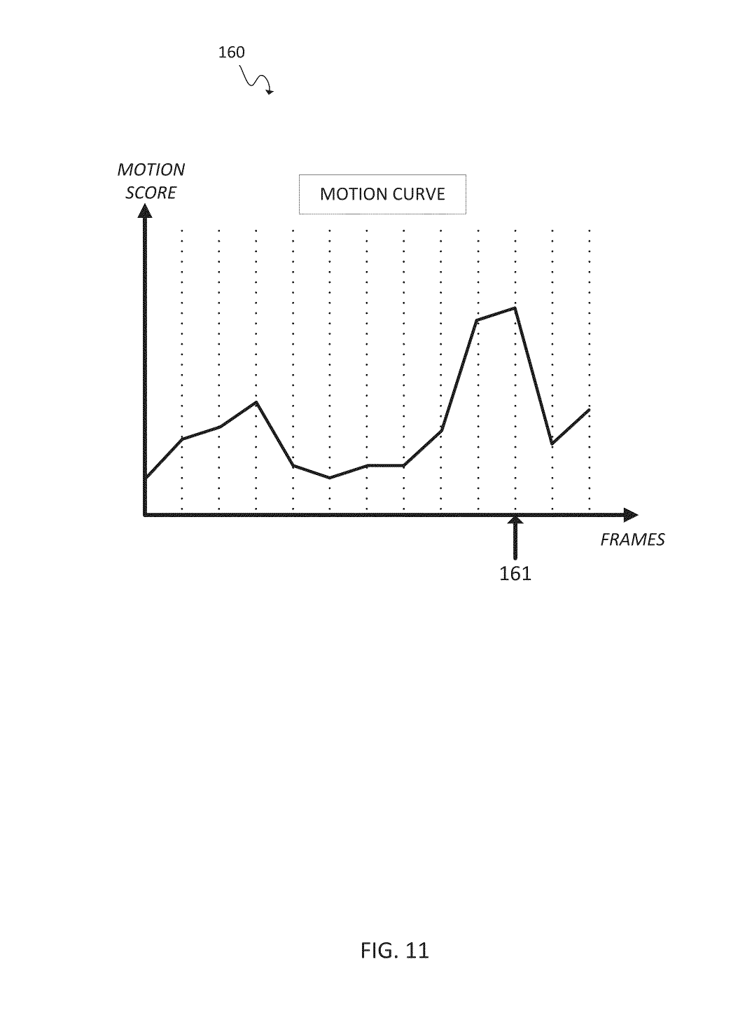

FIG. 11 illustrates an example plot of a motion curve 160 drawn based on multiple motion scores in a series of video frames or a series of time periods. Higher motions scores correspond to more movement in the video, and lower motion scores correspond to less movement in the video. The server 125 may identify a frame, time period, or portion of the video sequence based on the motion scores. The server 125 may identify the highest motion score from the motion curve 160. The motion curve shown in FIG. 11 includes a maximum motion score 161. Alternatively, the server 125 may identify a predetermined number (e.g., 5, 10, or another number) of top motion scores or all of the motion scores that exceed a threshold. An identification flag may be set for the frames that correspond to the top motion scores. The identification flags may be stored with the video as metadata.

In one example, the video frames that correspond to the selected scores are used as a thumbnail. The thumbnail may be displayed on the mobile device 122 to represent the video sequence. The thumbnail may be displayed on a computer or a website when the video sequence is uploaded. In another example, the video frames that correspond to the selected scores are used as a highlight video. The set of frames that corresponds to the high motion score is played as a representation of the full video. The highlight video may be played when hovering over the thumbnail of the video sequence.

In another example, the video frames that correspond to the selected scores are stored and the remaining video is discarded. For example, a security video may record continuously. The video files may grow to be very large. The server 125 may analyze the motion score of sections of the security video and discard sections with low motion scores. The sections with low motion scores may include no activity. The sections that are retained require less storage space. Similar video editing may be done with videos of wildlife or natural phenomenon.

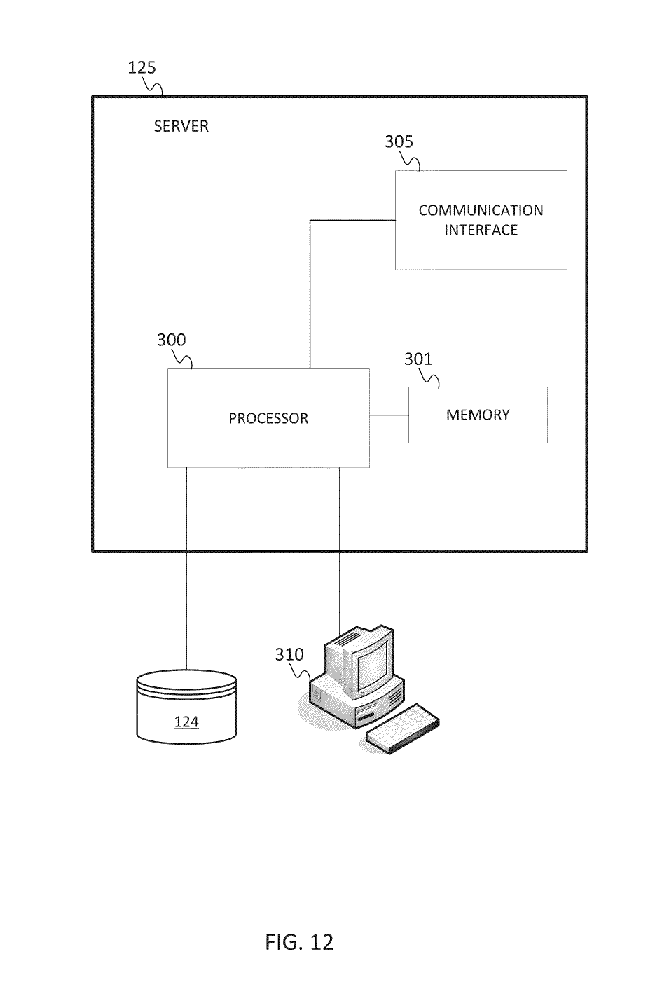

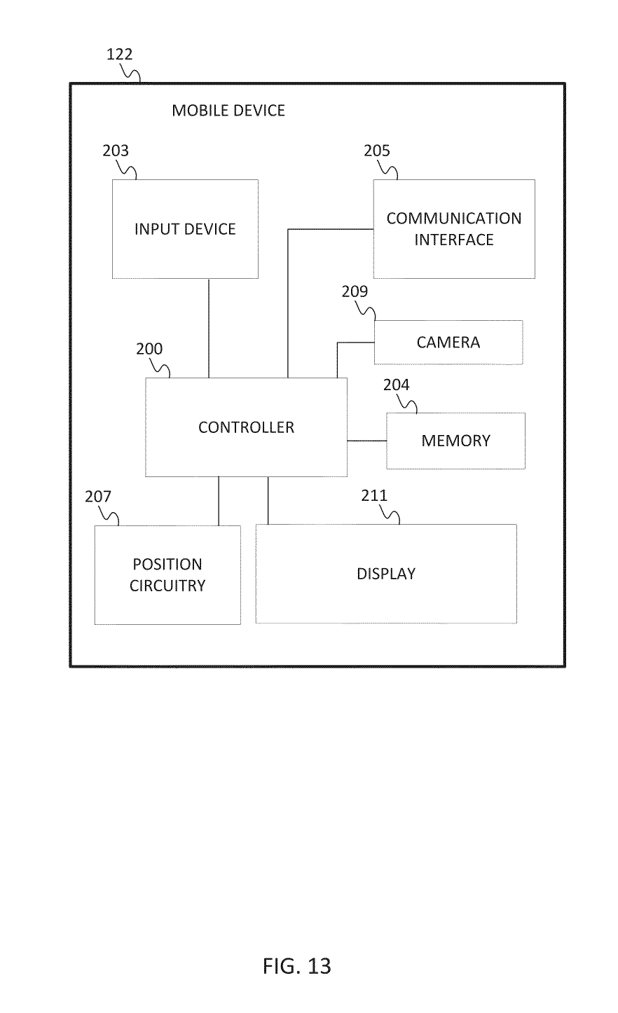

FIG. 12 illustrates an exemplary server of the system of FIG. 1. The server 125 includes a processor 300, a communication interface 305, and a memory 301. The server 125 may be coupled to a database 124 and a workstation 310. The workstation 310 may be used as an input device for the server 125. In addition, the communication interface 305 is an input device for the server 125. The communication interface 305 receives data indicative of use inputs made via the workstation 310 or the mobile device 122.

The memory 301 is configured to store a video sequence. The video sequence may be a video clip or stream distributed by a website. The video sequence may be uploaded by a user (e.g., from mobile device 122). The server 125 may identify the salient features of the video clip and/or add the slow motion timing to the video clip.

The processor 300, which may be any type of controller, is configured to select a subset of frames from the video sequence based on a focus frame identifier and a slow motion timing pattern and generate at least one intermediate frame for insertion into the subset of frames based on the slow motion timing pattern for the video sequence and the focus frame identifier for the video sequence.

In one example, the processor 300 receives the video sequence at a high resolution and converts the video sequence to a lower resolution. The processor 300 may be configured to reduce the resolution of the video or otherwise downsample the video. The downsampling may occur in real time, in a frame by frame basis, or over a time period. In one example, the images may be converted to a low fixed resolution. Example low resolutions include 512 pixels by 256 pixels or 256 pixels by 128 pixels. The lower resolution may be a predetermined resolution or selected by user input. The lower resolution allows faster analysis of the video sequence. For the output video, the higher resolution and/or full color versions of the video sequence may be used.

The processor 300 may identify a slow motion timing pattern for a video sequence. The slow motion timing pattern may be selected from a lookup table stored in the memory 301. The lookup table may associate types or categories of videos with slow motion timing patterns or retiming sequences. For example, high action videos with high motion trajectories (e.g., sports, racing, hunting, or stunt videos) may be associated with longer slow motion spans and/or a higher number of interpolated frames. Low action videos (e.g., security, surveillance, or wildlife videos) may be associated with a lower number of interpolated frames. Medium action videos (e.g., movies, music, or normal activity videos) may be associated with a medium slow motion span or a medium number of interpolated frames.

The processor 300 is configured to access a focus frame identifier for the video sequence. The focus frame identifier may be stored in the memory 301. The focus frame identifier may be generated based on a user input. The user may select a location in the video sequence that is listed by the focus frame identifier. The focus frame identifier may list a salient feature automatically identified by the processor 300, as described below. The processor 300 is configured to select a subset of frames from the video sequence. The span of the subset of frames may be set based on the slow motion timing pattern. The location of the subset of frames may be set based on the focus frame identifier.

The processor 300 is configured to generate the interpolated frames by average the location of pixels or objects in the images or by using the optical flow algorithms described above. The processor 300 is configured to insert the interpolated frames according to the slow motion timing pattern. The slow motion timing pattern may define a number of intermediate frames to insert between a pair of the subset of frames. The slow motion timing pattern may define multiple quantities of frames such that a quantity is listed for insertion between each pair of the subset of frames. 16. In one example, the slow motion timing pattern may include a build-up slope for an increasing number of intermediate frames between frames preceding the focus frame, and a trail-off slope for a decreasing number of intermediate frames between frames following the frame described by the focus frame identifier. The absolute value of the tail-off slope is greater than an absolute value of the build-off slope.

The processor 300 may be configured to automatically salient features open which may be listed by the focus frame identifier. The processor 300 processes video images by calculating motion vectors for time ranges in the video. The motion vectors may be computed from the downsampled images. The motion vectors describe the movement of objects in the images. The motion vectors may describe the movement of one or more pixel attributes from one pixel location to another pixel location. The time ranges may be groups of frames or predetermined time durations. The processor 300 is configured to sort the motion vectors based on direction. The direction of the motion vector may be calculated as the arc tangent of a first component of the motion vector divided by a second component of the motion vector. The processor 300 may sort the motion vectors into multiple orientation ranges.

The processor 300 may perform a comparison of the motion vectors in pairs of subsequent time ranges or pairs of subsequent frames. A motion score is calculated for the comparison of each pair of subsequent time ranges or each pair of subsequent frames. The processor 300 may identify the screenshot with the highest motion score in the video, the section of video with the highest average score, or discard frames that do not meet a threshold store.

To identify the screenshot or frame with the most activity, the processor 300 compares the motion score for each of the subsequent time ranges to select a highest motion score. This frame or screenshot may be used as a thumbnail to represent the video. The processor 300 may extract this frame from the video. The processor 300 may assign a flag to the video that indicates this frame is the representative frame.

To identify the portion of the video with the most activity, the processor 300 may calculate an average motion score for time intervals of the video. Alternatively, the processor 300 may calculate a running average of motion score. For example, an average of the previous ten motion scores may be calculated at each time range. The average motion scores are compared to identify the section of video with the most activity, which may be referred to as the highlight time range. The processor 300 may generate and store a flag with frames of the highlight time range.

In another example, the processor 300 may compare the motion score for each of the subsequent time ranges to a threshold motion score. The threshold motion score may be set low to distinguish frames in which no activity is occurring. The threshold motion score may be set high to distinguish the most active frames. The processor 300 may store a flag with one or more frames of the video associated with motion scores that exceed the threshold motion score. The processor 300 may delete one or more frames of the video associated with motion scores below the threshold motion score.

In any of these examples, the flags defined by the processor 300 may be used as advance points. Advance points are bookmarks in the video that define a stopping point for advancing the video. For example, when the video is playing, the playback application may include an advance command. When the advance command is activated, the playback application advances to the next advance point. Accordingly, a user can skip ahead to the next portion of the video that includes significant video.

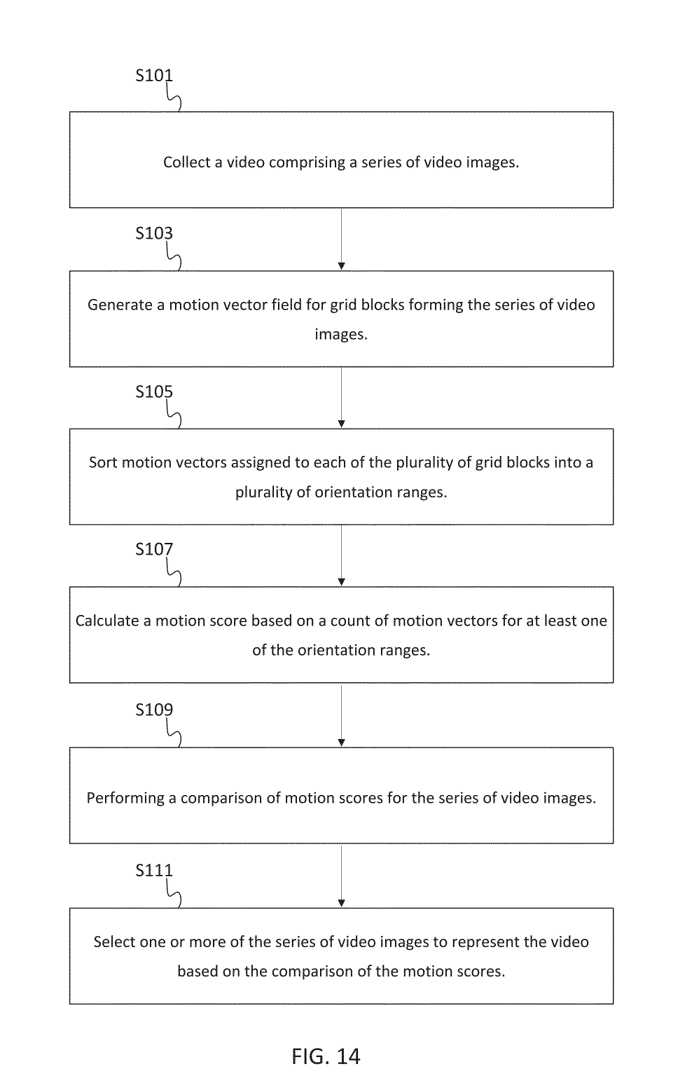

FIG. 14 illustrates an exemplary mobile device of the system of FIG. 1. The mobile device 122 includes a controller 200, a memory 204, an input device 203, a communication interface 205, a camera 209, and a display 211. FIG. 14 illustrates an example flowchart for identifying salient features in a video, which is described in relation to the mobile device 122 but may be performed by another device. Additional, different, or fewer acts may be provided.

At act S101, the camera 209 collects a video comprising a series of video images. Example video formats include .wav, .mp3, .mp4, .wma, 3gPP multimedia file, or other formats. The controller 200 may process the video in real time as the video is collected or after the video has been stored.

At act S103, the controller 200 generates a motion vector field for grid blocks forming the series of video images. The grid blocks subdivide the video images in any shape or size. In one example, only the middle portion (e.g., middle 50% or middle 80%) of the images are assigned grid blocks. In another example, the entire images are divided into grid blocks.

At act S105, the controller 200 sorts motion vectors assigned to each of the plurality of grid blocks into orientation ranges. The orientation ranges divide the motion vectors based on the direction of movement. At act S107, the controller 200 calculates a motion score based on a count of motion vectors for at least one of the orientation ranges. The count may represent the quantity of motion vectors that point in a particular direction. The count may be increased or decreased based on the magnitude of the motion vectors counted. The motion score describes how much activity is moving in a particular direction.

At act S109, the controller 200 performs a comparison of motion scores for the series of video images. At act S111, the controller 200 selects one or more of the series of video images to represent the video based on the comparison of the motion scores. The controller 200 may select the lowest motion score as a still shot to represent the video. The controller 200 may select the highest motion score as an action shot, which may be the most interesting portion of the video.

Alternatively, the processor 300 of the server 125 performs one or more of acts S103, S105, S107, S109, and S111. The display 211 may display the selection portion of the video. The input device 203 is configured to receive a selection for defining the selection of the representative frame. The input may define whether a frame with the highest motion score (e.g., thumbnail) should be selected, a group of frames with the highest running average of motions scores (e.g., highlight clip) should be selected, or whether video editing should be performed (e.g., discarding frame) based on the motion score comparison.

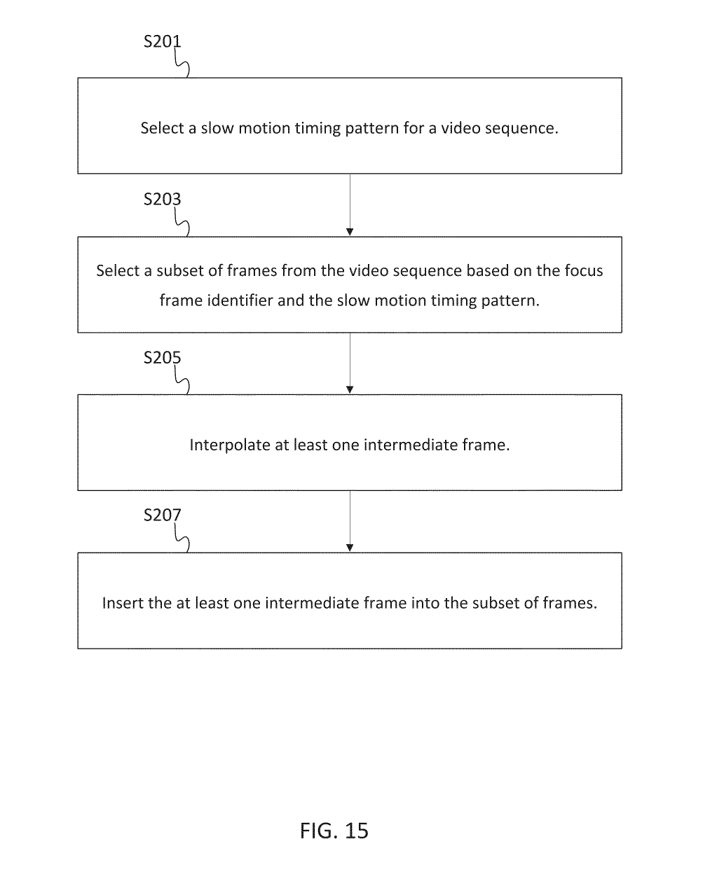

FIG. 15 illustrates an example flowchart for retiming a video sequence, which is described in relation to the mobile device 122 but may be performed by another device. Additional, different, or fewer acts may be provided.

At act S201, the controller 200 selects a slow motion timing pattern for a video sequence. The timing pattern may be stored in memory 204. The slow motion timing pattern may be selected from a user input at input device 203. The slow motion timing pattern may be defined by one or more inputs including duration, rate of decrease of speed, and minimum speed.

At act S203, the controller selects a subset of frames from the video sequence based on retiming point (e.g., focus frame) in the video sequence and the slow motion timing pattern. The retiming point may be identified by timestamp or frame number. The focus frame identifier may be received from a scrubber bar at the input device 203. The slow motion timing pattern defines the duration of the slow motion, and the quantity of the subset of frames may be selected based on the duration of the slow motion.

At act S205, the controller 200 interpolates at least one intermediate frame. The intermediate frames include object that appear at one or more of the frames of the subset of frames but at different location. The new locations for the objects may be determined based on motion vectors. At act S207, the controller 200 inserts the intermediate frames into the subset of frames so that the video sequence may be played including the intermediate frames given the appearance of slow motion.

Alternatively, the processor 300 of the server 125 performs one or more of acts S201, S203, S205, and S207. In these embodiments, the camera 123 may collect the video, and the display 211 may display the selection portion of the video, while the image processing is performed by the server 125.

The input device 203 may be one or more buttons, keypad, keyboard, mouse, stylist pen, trackball, rocker switch, touch pad, voice recognition circuit, or other device or component for inputting data to the mobile device 122. The input device 203 and the display 211 may be combined as a touch screen, which may be capacitive or resistive. The display 211 may be a liquid crystal display (LCD) panel, light emitting diode (LED) screen, thin film transistor screen, or another type of display.

Positioning circuitry 207 is optional and may be excluded. Location data from the positioning circuitry 207 may be added to the video as metadata. The positioning circuitry 207 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 207 may include suitable sensing devices that measure the traveling distance, speed, direction, and so on, of the mobile device 122. The positioning system may also include a receiver and correlation chip to obtain a GPS signal. Alternatively or additionally, the one or more detectors or sensors may include an accelerometer built or embedded into or within the interior of the mobile device 122. The accelerometer is operable to detect, recognize, or measure the rate of change of translational and/or rotational movement of the mobile device 122. The mobile device 122 receives location data from the positioning system. The location data indicates the location of the mobile device 122.

The controller 200 and/or processor 300 may include a general processor, digital signal processor, an application specific integrated circuit (ASIC), field programmable gate array (FPGA), analog circuit, digital circuit, combinations thereof, or other now known or later developed processor. The controller 200 and/or processor 300 may be a single device or combinations of devices, such as associated with a network, distributed processing, or cloud computing.

The memory 201 and/or memory 301 may be a volatile memory or a non-volatile memory. The memory 201 and/or memory 301may include one or more of a read only memory (ROM), random access memory (RAM), a flash memory, an electronic erasable program read only memory (EEPROM), or other type of memory. The memory 201 and/or memory 301 may be removable from the mobile device 100, such as a secure digital (SD) memory card.

The communication interface 205 and/or communication interface 305 may include any operable connection. An operable connection may be one in which signals, physical communications, and/or logical communications may be sent and/or received. An operable connection may include a physical interface, an electrical interface, and/or a data interface. The communication interface 205 and/or communication interface 305 provides for wireless and/or wired communications in any now known or later developed format.

The network 127 may include wired networks, wireless networks, or combinations thereof. The wireless network may be a cellular telephone network, an 802.11, 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols.

While the non-transitory computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method comprising:
receiving a video sequence;
selecting a retiming code for the video sequence;
accessing a focus frame identifier;
selecting a subset of frames from the video sequence based on the focus frame identifier and the retiming code;
interpolating at least one intermediate frame using at least one motion vector defined by the subset of frames; and
inserting the at least one intermediate frame into the subset of frames.

2. The method of claim 1, wherein the at least one motion vector includes a first motion vector and a second motion vector.

3. The method of claim 2, further comprising:
calculating the first motion vector using an optical flow algorithm from a first frame of the subset of frames to a second frame of the subset of frames; and
calculating the second motion vector using the optical flow algorithm from the second frame of the subset of frames to the first frame of the subset of frames.

4. The method of claim 1, wherein the at least one intermediate frame includes a first quantity of intermediate frames and a second quantity of intermediate frames.

5. The method of claim 4, wherein inserting the at least one intermediate frame into the subset of frames comprises:
inserting the first quantity of intermediate frames after a first frame of the subset of frames; and
inserting the second quantity of intermediate frames after a second frame of the subset of frames.

6. The method of claim 5, wherein the second quantity of frames includes one more frame than the first quantity of frames.

7. The method of claim 5, wherein the retiming code defines the first quantity and the second quantity.

8. The method of claim 1, further comprising:
generating a motion vector field for a plurality of pixels in the video sequence;
binning motion vectors assigned to a plurality of orientation ranges; and
calculating a motion score based on a count of motion vectors for at least one of the orientation ranges; and
generating the focus frame identifier based on the motion score.

9. The method of claim 1, further comprising:
receiving the video sequence at a first resolution; and
downsampling the video to a second resolution prior to interpolating at least one intermediate frame.

10. An apparatus comprising:
at least one processor; and
at least one memory including computer program code for one or more programs; the at least one memory and the computer program code configured to, with the at least one processor, cause the apparatus to at least perform:
selecting a slow motion timing pattern for a video sequence;
accessing a focus frame identifier for the video sequence;
selecting a subset of frames from the video sequence based on the focus frame identifier and the slow motion timing pattern;
interpolating at least one intermediate frame; and
inserting the at least one intermediate frame into the subset of frames.

11. The apparatus of claim 10, wherein the slow motion timing pattern defines a number of intermediate frames to insert between a pair of the subset of frames.

12. The apparatus of claim 10, wherein the slow motion timing pattern defines a number of intermediate frames to insert between each pair of the subset of frames.

13. The apparatus of claim 10, wherein the at least one intermediate frame is interpolated using at least one motion vector defined by the subset of frames.

14. The apparatus of claim 13, wherein the at least one motion vector includes a first motion vector and a second motion vector.

15. The apparatus of claim 14, wherein the at least one memory and the computer program code configured to, with the at least one processor, cause the apparatus to at least perform:
calculating the first motion vector using an optical flow algorithm from a first frame of the subset of frames to a second frame of the subset of frames; and
calculating the second motion vector using the optical flow algorithm from the second frame of the subset of frames to the first frame of the subset of frames.

16. The apparatus of claim 10, wherein the slow motion timing pattern includes a first slope for frames preceding a frame described by the focus frame identifier and a second slope for frames following the frame described by the focus frame identifier.

17. The apparatus of claim 16, wherein an absolute value of the second slope is greater than an absolute value of the first slope.

18. The apparatus of claim 10, wherein the slow motion timing pattern follows a normal distribution curve.

19. The apparatus of claim 10, wherein the focus frame identifier is based on a motion score of motion vectors for motion vectors assigned to a plurality of orientation ranges.

20. An apparatus comprising:
a memory configured to store a video sequence;
a processor configured to select a subset of frames from the video sequence based on a focus frame identifier and a slow motion timing pattern and generate at least one intermediate frame for insertion into the subset of frames based on the slow motion timing pattern for the video sequence and the focus frame identifier for the video sequence.
